(19) United States
(12) Patent Application Publication
(10) Pub. No.: US 2014/0226549 A1
(43) Pub. Date: Aug. 14, 2014

(54) Optimal Energy Efficient Bandwidth Aggregation System

(71) Applicant: Carnegie Mellon University, Pittsburg, PA (US)

(72) Inventors: Kahled A. Harras, Pittsburgh, PA (US); Moustafa Amin Youssef, Alexandria (EG); Karim Habak, Atlanta, GA (US)

(73) Assignee: CARNEGIE MELLON UNIVERSITY, Pittsburgh, PA (US)

(21) Appl. No.: 14/179,638

(22) Filed: Feb. 13, 2014

Related U.S. Application Data
(60) Provisional application No. 61/850,432, filed on Feb. 14, 2013.

(51) Int. Cl. H04W 52/02; H04W 72/12

(52) U.S. Cl. CPC H04W 52/0203; H04W 72/1205
USPC 370/311

(57) ABSTRACT

A novel optimal, energy-efficient, and deployable bandwidth aggregation system for multiple interface enabled devices has been developed which satisfies the goal of achieving a user defined throughput level with optimal energy consumption over multiple interfaces, deployability without changes to current legacy servers, and leveraging incremental deployment to achieve increased performance gains.

### RELATED APPLICATIONS

This application claims the benefit of U.S. provisional application Ser. No. 61/850,432, filed Feb. 14, 2013.

### BACKGROUND OF THE INVENTION

With the continuous advances in technology, decreasing cost of electronics, and increased user demand for mobile data, it is the norm nowadays to find devices with various network interfaces. These devices such as laptops, netbooks, tablets, and various smart phones, are equipped with a variety of networking interfaces to communicate with any technology available, such as Bluetooth, Wi-Fi, 3G/4G and WiMax (w/max). Such devices, however, are currently not able to utilize these existing interfaces together to enhance the overall system performance.

There have been many approaches that address the multiple interface bandwidth aggregation problem over the years. These techniques are implemented at different layers of the protocol stack. Application layer solutions typically require applications to be aware of the existence of multiple interfaces and be responsible for utilizing them. Socket level solutions, on the other hand, modify the kernel socket handling functions to enable existing applications to use multiple interfaces. Although this method does not modify existing applications, it requires changes to the legacy servers in order to support these new sockets. In addition, some methods require feedback from the applications about their performance, and hence are not backwards compatible with previous versions of the applications.

Many bandwidth aggregation techniques, however, naturally lie in the transport layer. These solutions replace TCP with mechanisms and protocols that handle multiple interfaces. Such techniques require changes to the legacy servers and hence have a huge deployment barrier. Finally, network layer approaches update the network layer to hide the variation in interfaces from the running TCP protocol. One known method requires having a proxy server that communicates with the client and is aware of the client's multiple interfaces. Others implement their system at both connection ends which makes their deployment reliant on updating the legacy servers. It is also known to require having a special router as well as an optional proxy server. The fact that modern operating systems, such as Windows, MAC OS, and Linux, allow users to use only one of the available interfaces, even if multiple of them are connected to the Internet, attest that all the current proposals for bandwidth aggregation face a steep deployment barrier.

The solutions described, however, mainly focus on leveraging these interfaces to increase system throughput, while overlooking all other aspects that characterize an optimal, energy-efficient, and deployable bandwidth aggregation system. An effective bandwidth aggregation system should be: (1) Easily deployable without requiring changes to legacy servers, applications, or the addition of new hardware (such as proxy servers); (2) Energy-efficient to conserve the limited battery resources of mobile devices while being flexible in meeting the needs of users of optimal throughput, if required; and (3) Leveraging incremental system adoption and deployment to further enhance performance gains.

Previous work in deployable bandwidth aggregation systems (DBAS) focuses on the actual implementation of the basic core system. This work was then extended with G-DBAS which added energy awareness to the basic DBAS systems. These systems, however, either operate only in the connection-oriented mode, or do not provide optimal scheduling algorithms that exploit the full potential of the interfaces available.

### SUMMARY OF THE INVENTION

A novel optimal, energy-efficient, and deployable bandwidth aggregation system for multiple interface enabled devices has been developed. The system is based on a middleware that lies right below the application layer, requiring no changes to either the OS kernel nor the applications. The system uses multiple interfaces simultaneously by partitioning and distributing data across them to achieve higher throughput while minimizing energy consumption.

The architecture of the present system is such that it can work with current legacy servers and leverage any enabled servers to further enhance performance. One of the core functionalities of the middleware of the invention is to schedule different connections to different interfaces. The scheduling problem has been formulated to allow the user to achieve a desired throughput with minimal energy consumed. It is demonstrated that this is a mixed integer programming problem that has a special structure allowing it to be efficiently solved.

The system was evaluated via implementation on the Windows OS, as well as via simulation, and the results were compared to the optimal achievable throughput and energy consumption. The results show that, with no changes to the current legacy servers, the system can achieve a 150% enhancement in throughput as compared to the current operating systems, with no increase in energy consumption. In addition, with only 25% of the nodes becoming enabled, the system performance reaches the throughput upper-bound. This highlights that the invention achieves the goals of being optimal, energy efficient, as well as easily and incrementally deployable.

### DESCRIPTION OF THE DRAWINGS

FIG. 1 illustrates the system architecture and scheduling parameters.

FIG. 2 illustrates the impact of changing the stream-type mix. (γ=0 for all steams connection-based, i.e., zero network support), plotting (a) throughput and (b) energy consumption per unit data.

FIG. 3 illustrates the impact of interface dynamics (bandwidth) on performance, plotting (a) throughput and (b) energy consumption per unit data.

FIG. 4 illustrates the impact of changing the utility value (α) on performance, plotting (a) throughput and (b) energy consumption per unit data.

FIG. 5 shows the effect of using different utility functions: (a) different utility function outputs, (b) total data transmitted, and (c) total energy consumption.

FIG. 6 illustrates the impact of changing the connection heterogeneously (λ_{Large}), plotting (a) throughput and (b) energy consumption per unit data.

FIG. 7 illustrates the effect of application characteristics estimation error on performance, plotting (a) throughput and (b) energy consumption per unit data.

FIG. 8 is a comparison with baseline schedulers, plotting (a) throughput and (b) energy consumption per unit data.

### DETAILED DESCRIPTION OF THE INVENTION

This invention describes an optimal, energy-efficient, deployable bandwidth aggregation system for multiple interface enabled devices.

System Architecture

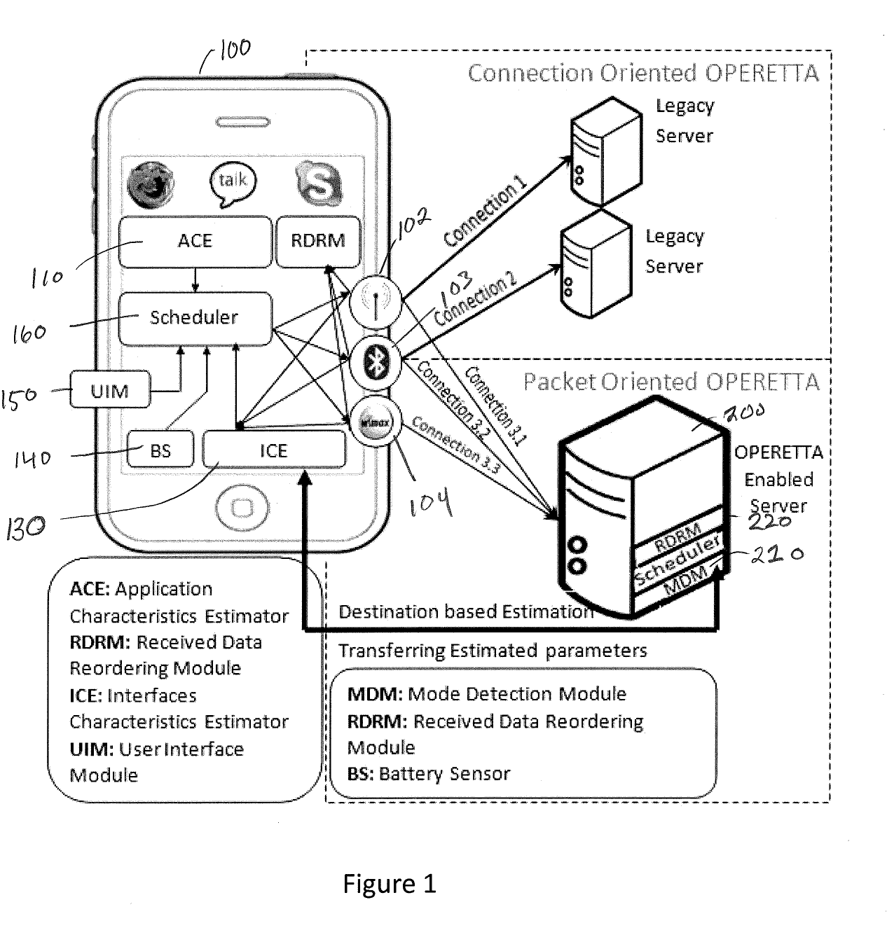

In reference to FIG. 1, in a client 100 equipped with multiple network interfaces connected to the Internet, each interface will have individual characteristics in terms of bandwidth, latency, loss ratio, and energy consumption. The host runs multiple applications with varying communication characteristics. In a first operational mode of the invention, different connections to the interfaces are scheduled such that a connection is assigned to only one of the available interfaces. Once assigned to an interface, all the packets of this connection utilize the same interface. As such, the invention achieves bandwidth aggregation without requiring any changes to legacy servers (the server deals with a normal connection).

In a second operational mode, if the other end of the connection (i.e., server 200) is also equipped with components of the invention (hereinafter referred to as being “enabled”), the system is able to further enhance performance by switching to a packet-based mode, where each packet can be scheduled independently on a different interface.

The system is composed of the following components as shown in FIG. 1.

Application Characteristics Estimator 110. To be fully deployable, the invention does not require any changes to existing applications. Knowing the application characteristics, however, enables full utilization of the available interfaces and allows the system to make better scheduling decisions. Application characteristics estimator 110 automatically estimates the characteristics of the applications based on their behavior. These characteristics are stored in a database for keeping track of the behavior of the applications. The characterization of the applications utilizes both qualitative and quantitative measures.

In qualitative measures, application characteristics estimator 110 uses some features to characterize the behavior of an application. For example, the process name can be used to determine whether the process is realtime (e.g. Skype), or bandwidth intensive (e.g. an FTP client). Similarly, specific ports reserved by the application can also be used to characterize the behavior of the application.

In quantitative measures, application characteristics estimator 110 also estimates the average connection data demand in bytes for any given application. After a connection is terminated, application characteristics estimator 110 updates the estimated values of connection data demand (C_{demand}) as:

C_{demand}=(1−α)C_{demand}+αCC_{demand} (1)

where CC_{demand} is the number of bytes transmitted by the terminated connection and a is a smoothing coefficient, taken equal to 0.125 to evaluate the equation efficiently. Note the granularity of estimation can be rendered more fine grained at the expense of increased complexity and lower scalability.

Mode Detection Module 200. The purpose of mode detection module 210 is to detect whether the end point of the connection (server 200) supports the invention such that the second mode of operation, the packet-oriented mode, may be enabled. This module is implemented as a service that runs on a specific port reserved for the invention. When client 100 tries to establish a new connection, it first attempts to open a dummy connection to this portion server 200. If successful, this indicates that the invention is supported at the end point and, as such, the packet-oriented mode can be used.

If packet-oriented mode is enabled, multiple connections to the destination will be seamlessly opened from the application over multiple interfaces (shown in FIG. 1 as a Wi-Fi connection 102, a BlueTooth connection 103 and a w/max connection 104, although any combination of interfaces could be used) and will distribute the data across those interfaces. Otherwise, connection-oriented mode is used, wherein each application is assigned a specific interface. To avoid the delay of determining the operation mode, the connection-oriented mode can be used simultaneously while probing server 110.

Interface Characteristics Estimator 130. This module is responsible for estimating the characteristics of each network interface. In particular, it estimates the available bandwidth at each interface. It periodically connects and communicates with various geographically dispersed servers to estimate the uplink and downlink available bandwidth for each interface. These estimates are then combined with the statistics collected during the normal data transfer operation. These estimates are sufficient as the bandwidth bottlenecks typically exist at client 100 and not at server 105, which is typically connected to a high bandwidth link and designed to scale with the number of clients.
To characterize energy consumption, Table 1 shows how the power consumption of a network interface depends on the NIC and technology used. To estimate the energy consumption for its attached network interfaces, an online service with a database containing the energy consumption rates for various network interfaces was built. To discern energy consumption rates for each network interface, the database is queried for the energy consumption rates of each network interface. This can also be estimated dynamically during the device operation.

TABLE 1
Power Consumption Table

| | | Low-Power | | | |
|---|---|---|---|---|---|
| Interface | Technology | Idle | | Active Tx | |
| Netgear MA701 | Wi-Fi | 264 | mW | 990 | mW |
| Linksys WCF12 | Wi-Fi | 256 | mW | 890 | mW |
| BlueCore3 | Bluetooth | 25 | mW | 120 | mW |
| GSM 850/900/1800/1900 | GPRS | 0.4 | W | 1.27 | W |

Battery Sensor 1400. This module senses the available battery level and whether or not client 100 is plugged to a power source or running on battery.

User Interface Module 150. This module is responsible for obtaining the user's preferences and interface usage policies (utility). The user can configure this module to enforce some interface selection criteria. For example, the user may wish to assign specific applications (e.g. realtime applications) to specific interfaces (e.g. wired). Similarly, the user might prefer to reduce cost and give higher priority/weight to interfaces that have a free connection or low energy.

Received Data Reordering Module 220. This module is utilized in the packet-oriented mode. It is responsible for reordering the incoming data chunks from different interfaces and to pass them on to the application layer at the receiving end. This is enabled by the sender adding a special header to each data packet which only contains a “chunkId” that is used in reordering the “chunks” when they reach the destination. When an interface is down, unacknowledged chunks can be re-sent over other interfaces, showing the effect of connection migration.

Scheduler 160. This module is the core of the invention. It uses the application, interface characteristics estimators, and the device status to schedule the connections to different interfaces. Table 2 contains a list of symbols used in the description of scheduler 160.

TABLE 2
List of Symbols Used

| Symbol | Description |
|---|---|
| T | The overall system throughput |
| L | The current system load |
| Lᵢ | The current system load for stream i |
| Sᵢ | Determines whether stream i is connection based (1) |
| | or packet-based (0) |
| γⱼ | The effective bandwidth of interface j |
| αⱼ | Difference in power between active and idle states |
| | of interface j |
| ε | The energy consumed in order to transfer the system load |
| εⱼ | The energy consumed for interface j to transfer its load |
| Δⱼ | The time needed for interface j to finish its load |
| xᵢⱼ | For connection-oriented streams, equals 1 if stream i |
| | is assigned to interface j. Equals 0 otherwise. |
| wⱼ | The ratio of packets assigned to interface j |
| n | Number of active streams including the new request |
| m | Number of interfaces |

For purposes of this description, assume a mobile device with m interfaces, each with rate and energy consumption rate of aⱼ, where aⱼ equals the difference in power consumption between the active and idle states of interface j. The device runs a set of applications that share these interfaces. A standard network connection is referred to as a stream. The goal of scheduler 160 is to assign streams to interfaces to minimize the required energy (ε) to achieve a desired throughput (T). Scheduling decisions are made when a new stream (number of streams active in the system is n, including the new stream) is requested from an application. Mode detection module 220 determines whether the operation mode is connection-based (Sₙ=1), or packet-based (Sₙ=0), if server 200 is enabled. If the operation mode is connection-based, the goal of scheduler 160 is to determine which interface the connection should be assigned (sets xₙⱼ=1 for only one interface j) to each application. In either case, the percentage of packets to be assigned to each interface, i.e. interfaces relative packet load (wⱼ), is re-calculated based on the current system load (L).

Utility Function

The target throughput for scheduler 160 is set based on a user utility function that balances the system throughput and the energy consumption. At one extreme, the goal of scheduler 160 can be to minimize energy (E) required to consume the system load. This can be achieved by assigning all traffic (streams) to the interface (iₚ_{ₘᵢₙ}) with the minimum energy consumption per bit, achieving a throughput of rᵢ_{ₚₘᵢₙ}. At the other extreme, the goal of scheduler 160 may be to maximize system throughput (T), in which case, all interfaces should be carefully utilized to maximize throughput, regardless of the consumed energy. In this case, the maximum achievable throughput is Σᵢ rᵢ. In between, a parameter α, 0≦α≦1, is used to tune the system performance between these two extremes achieving a throughput of rᵢ_{ₚₘᵢₙ}+αΣᵢ₊ᵢ_{ₚₘᵢₙ} rᵢ. This α is chosen based on a user utility function that reflects user preferences.

Optimal Scheduling

Here is described the objective function and system constraints. The decision variables are: (1) If Sⱼ=1, which interface to assign the new stream to (variable xₙⱼ) and (2) the new values for wⱼ, ∀ⱼ: 1≦j≦m.

Objective Function:

The overall objective of the scheduler is to minimize the overall system energy consumption (E) to consume the system load:

$$Minimized ɛ = {\sum }_{j} {ɛ}_{j}$$

where, Eⱼ is the energy consumption of interface j. For interface j, this energy can be divided into two parts: (1) energy needed to finish the load of the connection-oriented streams and (2) energy needed to finish the load of the packet-oriented streams. The former is equal to aⱼtⱼ, where tⱼ is the time required for interface to finish its connection-oriented load, tⱼ=Σ₌₁^{m}Lᵢ Sᵢxᵢⱼ/rⱼ. Similarly, the latter is equal to Σᵢⁿ=aⱼ thcal Lᵢ(1−Sᵢ)wⱼ/rⱼ. Since connection-oriented streams cannot be re-assigned to other interfaces, the objective function becomes:

$$Minimize ɛ = {\sum }_{j = 1}^{m} \frac{{a}_{j}}{{r}_{j}} ( {w}_{j} {\sum }_{i = 1}^{n} ( {ℒ}_{i} ( 1 - ) ) + {ℒ}_{n} {n}_{} {x}_{nj} ) \qquad ( 2 )$$

Constraints:

The following constraints must be satisfied:

Target Throughput: As defined above, the user utility function defines a minimum throughput that should be achieved (T_{Target}=rᵢ_{ₚₘᵢₙ}+αΣ_{i±i}_{ₚₘᵢₙ} rᵢ). Therefore,

$$𝒯 = \frac{ℒ}{{max}_{j} {Δ}_{j}} \geq {𝒯}_{Target} \qquad ( 3 )$$

where Δ₁ is the time needed by interface j to finish all its load (connection and packet based).

$$\to {∀}_{j} , {Δ}_{j} = \frac{{\sum }_{i = 1}^{n} ( {ℒ}_{i} ( 1 - {i}_{} ) {w}_{j} ) + {\sum }_{i = 1}^{n} ( {ℒ}_{i} {i}_{} {x}_{ij} )}{{r}_{j}} \leq \frac{ℒ}{{𝒯}_{Target}}$$

Rearranging:

$$\to {∀}_{j} , {w}_{j} = {\sum }_{i = 1}^{n} ( {ℒ}_{i} ( 1 - {i}_{} ) ) + {ℒ}_{n} {n}_{} {x}_{nj} \leq \frac{ℒ {r}_{j}}{{𝒯}_{Target}} {\sum }_{i = 1}^{n - 1} ( {ℒ}_{i} {i}_{} {x}_{ij} ght ) \qquad ( 4 )$$

Note that the RHS is constant.

Integral Association: If the new stream is connection-oriented, it should be assigned to only one interface:

$${\sum }_{j = 1}^{m} {x}_{nj} + ( 1 - {n}_{} ) - 1 \qquad ( 5 )$$

Note that when Sₙ=0, xₙⱼ=0, ∀j, which is the case when the new stream is determined to be packet-based by the Mode Detection Module.

Packet Load Distribution: For packet-oriented streams, their total load should be distributed over all interfaces:

$${\sum }_{j = 1}^{m} {w}_{j} = 1 \qquad ( 6 )$$

Variable Ranges: The trivial constraints for the range of the decision variables

wⱼ≧0, 1≦j≦m (7)

xₙⱼ ∈ {0, 1}, 1≦j≦m (8)

Scheduling Algorithm

In summary, it is a goal of the invention to minimize the energy consumed based on Equation 2, while satisfying the set of constraints mentioned above. In general, this problem is a mixed 0-1 Integer Programming problem. However, it has a special structure that allows for an efficient solution. In particular, we have two cases: if the new stream that triggered the scheduling decisions is packet-based (Sₙ=0) and if it is connection-based (Sₙ=1). Algorithm 1 summarizes the algorithm of scheduler 160

Algorithm 1-Scheduling algorithm

```
    Input: Type of new stream (Sₙ), type of current streams (Sᵢ), their
    assignment to interfaces (xᵢⱼ), remaining load for each stream ( [symbol]  ),
    interfaces characteristics (rⱼ, aⱼ), and desired user utility (α).
    Output: Assignment of the new stream to an interface (xₙⱼ, xₙⱼ − 0 if
    packet-based) and new weights for distributing packet-based streams
    over each interface (wⱼ).
    Initialization: Order the interfaces in an ascending order according to
    $their energy consumption per unit data ( \frac{{a}_{i}}{{r}_{1}} ) .$
if The server is not enabled then
  for i − 1, . . . , m do
      xₙᵢ = 1; ∀_{k≠i}xₙₖ = 0
      $\begin{matrix}{𝒯}_{max} = \frac{ℒ}{{max}_{j} ( \frac{1}{{r}_{j}} {\sum }_{i}^{n} {ℒ}_{i} {𝒮}_{i} {x}_{ij} )} \\ {𝒯}_{Target} = min ( {r}_{1} + α {\sum }_{i = 1}^{m} {r}_{i} , {𝒯}_{max} )\end{matrix}$
      for j − 1, . . . , m do
        calculate ωⱼ using Equation 9
      end for
      calculate [symbol]   using Equation 2
      calculate [symbol]   using Equation 3
  end for
  $\begin{matrix}{x}_{ni} = 1 , if {x}_{ni} = 1 achieves 𝒯 \geq {r}_{1} + α {\sum }_{i = 1}^{m} {r}_{i} \\ with min ℰ or max 𝒯 if max 𝒯 < {r}_{1} + α {\sum }_{i = 1}^{m} {r}_{i}\end{matrix}$
else
  ∀ⱼ: xₙⱼ = 0
end if
$\begin{matrix}{𝒯}_{max} = \frac{ℒ}{{max}_{j} ( \frac{1}{{r}_{j}} {\sum }_{i}^{n} {ℒ}_{i} {𝒮}_{i} {x}_{ij} )} \\ {𝒯}_{Target} = min ( {r}_{1} + α {\sum }_{i = 1}^{m} {r}_{i} , {𝒯}_{max} )\end{matrix}$
for j = 1, . . . , m do
      calculate ωⱼ using Equation 9
end for
```

Solution for the packet-based case: In this case, xₙⱼ=0 ∀j. The problem becomes a standard linear programming problem. Actually, it can be mapped to the continuous Knapsack problem which can be solved in linear time. In particular, to minimize E, the interfaces with the smallest

$$\frac{a}{r}$$

are utilized in order. Therefore, the interfaces are sorted in an ascending order according to their

$$\frac{{a}_{i}}{{r}_{i}} .$$

Then from the throughput constraint (Equation 4) it's found that:

$${∀}_{j} {w}_{j} \leq \frac{ℒ {r}_{j} - {𝒯}_{Target} {\sum }_{i} ( {ℒ}_{i} {i}_{} {x}_{ij} )}{{𝒯}_{Target} {\sum }_{i} ( {ℒ}_{i} ( 1 - {i}_{} ) )}$$

It is then iterated on the interfaces setting wⱼ using the following formula:

$${w}_{j} = min ( 1 - {\sum }_{k < j} {w}_{k} , \frac{ℒ {r}_{j} - {𝒯}_{Target} {\sum }_{i} ( {ℒ}_{i} {i}_{} {x}_{ij} )}{{𝒯}_{Target} {\sum }_{i} ( {ℒ}_{i} ( 1 - {i}_{} ) )} ) \qquad ( 9 )$$

Solution for the connection-based case: In this case, the binary variables ∀ⱼxₙⱼ are determined such that only one of them equals 1 and others are 0. A quadratic time algorithm sets each one of them to 1 and then solves for ∀ⱼwⱼ using the linear time algorithm in the previous section. The values that have the minimum E are selected.

There are some interesting special cases that can be obtained from the general framework presented in this section. First, if the goal is to maximize throughput, i.e. α=1, then T_{Target}=Σ_{i±1}^{m}rᵢ. In addition, if all streams are packet-based, i.e. all servers are enabled, scheduler 160 reduces to a weighted round robin scheduler based on Equation 4. For the case when the user is interested in energy consumption, i.e. α<1, scheduler 160 is reduced to a weighted round robin scheduler for the subset of interfaces that have the least aᵢrᵢ ratio, based on the required saving in energy consumption. This means that the interfaces with high energy per bit consumption will be inactive, until we reach the extreme case of utilizing only the interface with the minimum energy per bit when α=0.

Implementation

The middleware providing the functionality of the invention was implemented as a Layered Service Provider (LSP), which is installed as part of the TCP/IP protocol stack under Windows OS, however implementations need not be restricted to Windows OS. This middleware uses the same concept adopted in implementing firewalls and network proxies to control traffic flows. The procedure starts when the application, aiming to connect to the Internet, uses the Winsock 2 API. Windows will dynamically link it to the Winsock 2 library which contains the implementation of all the Winsock 2 functions. This library sends its requests to the service provider which later forwards it to the base protocol, such as TCP/IP. Our LSP intercepts the Winsock 2 API requests and either schedules the connection to its selected interface or distributes data across the different network interfaces based on the mode of operation. In addition, it performs the functionality of the mode detection, application characteristic estimation, and interface characteristic estimation described above.

The monitoring application implemented represents the user interface module that captures the user's preferences and interface usage policies and further monitors behavior of the invention. This module is utilized to enable the user to enter the desired utility function as well as for testing purposes, where it allows the user to select one of the scheduling techniques outlined above. It also provides the ability to perform manual assignment of certain applications to certain interfaces. Finally, this module allows users to monitor internal data structures by interfacing with the middleware.

Performance Evaluation

Experimental Setup

Table 3 lists the main parameters employed in the evaluation. Without loss of generality, the testbed consists of four nodes: an enabled server, a legacy server, a client, and an intermediate traffic shaper node. Both servers are connection destinations. The intermediate node is a device running the NIST-NET network emulator to emulate the varying network characteristics of each interface. The client is the connection generator enabled with multiple network interfaces. On the client, different applications were run that vary in terms of the number of connections they open per second (β) and the average connection data demand (λ). The client is connected to the intermediate node through three interfaces: IF₁, IF₂ and IF₃ representing Wi-Fi, Bluetooth and GSM network interfaces. Each server is connected to the intermediate node using a high bandwidth link, L₁ and L₂. Note that the combined bandwidth of IF₁, IF₂ and IF₃ is less than each server bandwidth to test the impact of varying the interface characteristics and scheduling strategies. We define γ ∈ [0, 100] as the percentage of connections that have the enabled server as its destination. When γ=0 all the connections have the legacy server as their destination. However when γ=100 all the connections have the enabled server as their destination.

TABLE 3
Experiment Parameters

| | Value | Nominal |
|---|---|---|
| Parameter | range | Value |
| L₁ (Server #1) | 6 | 6 |
| Bandwidth(Mbps) | | |
| L₂ (Server #2) | 6 | 6 |
| Bandwidth(Mbps) | | |
| IF₁ | 0.25-2 | 1 |
| Bandwidth(Mbps) | | |
| IF₁ power | 634 | 634 |
| consumption | | |
| (mWatt) | | |
| IF₂ | 0.7 | 0.7 |
| Bandwidth(Mbps) | | |
| IF₂ power | 95 | 95 |
| consumption | | |
| (mWatt) | | |
| IF₃ | 2 | 2 |
| Bandwidth(Mbps) | | |
| IF₃ power | 900 | 900 |
| consumption | | |
| (mWatt) | | |
| βₛₘₐₗₗ | 13 | 13 |
| (Connections/sec) | | |
| β_{large} | 0-5 | 1 |
| (Connections/sec) | | |

The invention was evaluated using two classes of applications: small load, and large load. Small load applications represent typical web browsing applications with an average connection demand of λₛₘₐₗₗ=2138 KB. Large load applications, on the other hand, represent P2P and FTP applications with an average connection demand of λ_{large}=0.25 MB. The connection establishment rate follows a Poisson process with mean (β) connections per second. βₛₘₐₗₗ and β_{large} are changed to achieve different application mixes. Each experiment represents the average of 15 runs.

Overall, throughput and energy consumption per unit data are used for metrics while varying several parameters including user utility (α), stream type mix (γ), interface characteristics, and estimation error. We compare scheduler 160 to four baseline schedulers:

Throughput Optimal Scheduler: This imaginary scheduler represents the maximum achievable throughput.

Energy Optimal Scheduler: This imaginary scheduler represents the minimum energy consumption.

Round Robin (RR): Assigns streams or packets, based on the destination server type (legacy or enabled), to network interfaces in a rotating basis.

Weighted Round Robin (WRR): Similar to RR scheduler but weights each interface by its estimated bandwidth.

Results

The effect of the stream-type mix on the performance of the invention, its adoption to interface dynamics, its performance for different utility functions, its robustness to estimation error, and effect of connection heterogeneity are described herein. The performance of the invention to the baseline scheduling algorithms is also compared.

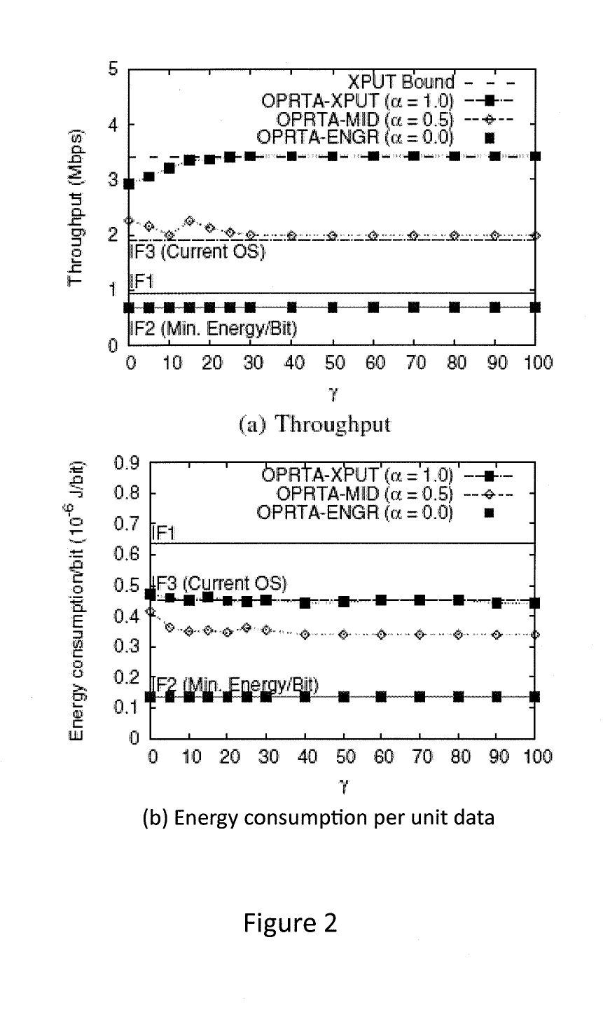

Impact of Stream-Type Mix (γ): As discussed, the invention performs best when all streams are packet-based as the scheduler can leverage the fine grained granularity to enhance the performance. FIG. 2 shows the effect of changing y on the performance for three user utility values (α): 1.0 (max. throughput), 0.0 (min. energy), and 0.5 (mix).

A number of interesting observations are revealed:
When γ is low, most of the streams are connection-oriented. This makes the scheduling decision coarse grained (once the stream is assigned to an interface, all its packets have to go through this interface until it terminates), reducing the optimality of scheduling.
For the throughput maximization mode (α=1), even with no servers that are enabled (γ=0), the invention can enhance the throughput by 150% as compared to the current Loss. The throughput upper bound is reached when only 25% of the streams are packet-based. In other words, to obtain the best possible throughput, the invention requires only 25% of the servers to be enabled. This gain comes with energy consumption that is equal to the same energy consumed by the current Loss (as shown in FIG. 2(b). This result highlights the significant gains achieved, in terms of throughput and energy, with the ability to support incremental deployment.
For the user utility value α=0.5, since the goal is to minimize the energy consumption under a given throughput constraint, solutions are favored that lead to minimum energy consumption. This is why throughput is sacrificed for the gain in energy as y increases.
Finally, to minimize energy (i.e., running in the minimum energy mode, α=0), the invention utilizes the interface with the minimum energy per bit, regardless of its throughput. Note that what matters is the energy consumed per bit and not the energy consumed per unit time (power). The former takes into account the fact that a faster interface that consumes slightly more power will consume less overall energy to transfer the same amount of data compared to a slow interface that consumes less power. For the remainder of the paper, we fix y at 25%.

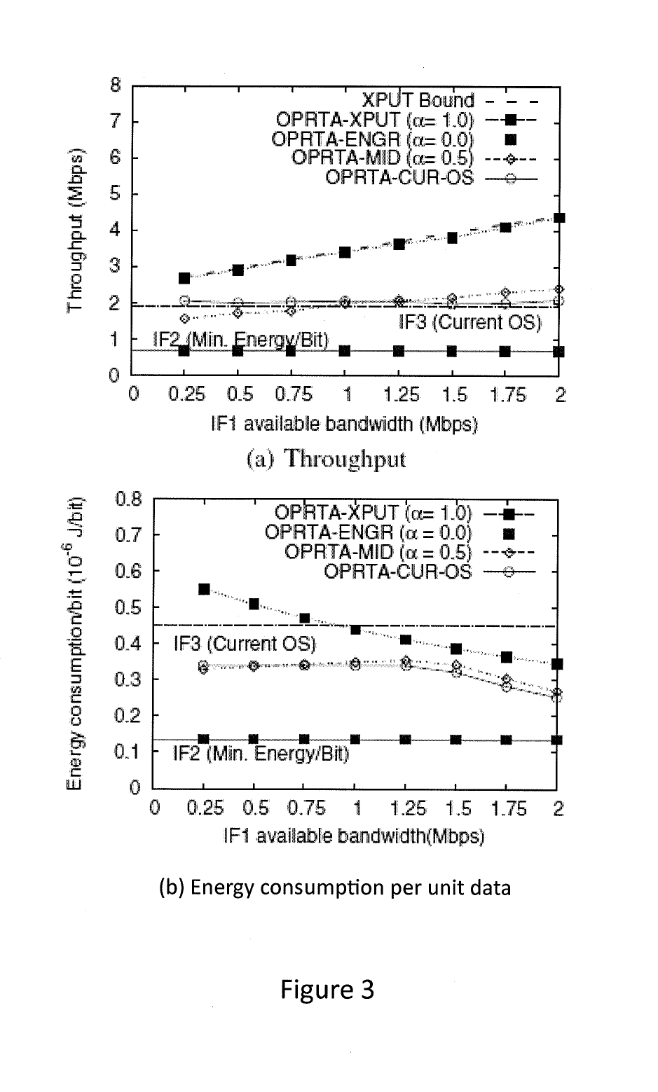

Impact of Interface Dynamics: The effects of dynamically changing the interface bandwidth were examined For this, we fix the bandwidth of IF₂ and IF₃ as shown in Table 3 and change the bandwidth of IF₁ from 0.25 to 2 Mbps. FIG. 3 shows that different variants of the invention, based on the user utility, behave differently under changing interface characteristics. The OPRTA-ENGR scheduler, whose goal is to minimize energy, always uses the interface with the minimum energy consumption per bit, regardless of the bandwidth. On the other hand, the variants that optimize for throughput (OPRTA-XPUT and OPRTA-MID) can leverage the increase of the IF₁ bandwidth to enhance the overall throughput. We introduce here another variant (OPRTA-CUR-OS) whose goal is to achieve the same throughput of the current OS's (i.e., that of IF₃) with the minimum energy consumption. This is highlighted in FIG. 3(b). The break in the energy consumption for the OPRTA-MID and OPRTA-CUR-OS variants at IF₁ bandwidth=1.5 Mbps can be explained by noting that at this point IF₁ energy consumption per bit becomes attractive. Therefore the two variants start using it for transmitting data.

Note that the usage of each interface changes as the bandwidth of IF₁ changes and becomes more attractive in terms of the energy consumed per bit for the OPRTA-CUR-OS variant. Even though the overall throughput may be constant, the used interfaces change to minimize the energy consumption as the system dynamics change. When IF₁ bandwidth reaches 1.5 Mbps, its it ratio becomes better than IF₃, and therefore, it completely replaces IF₃.

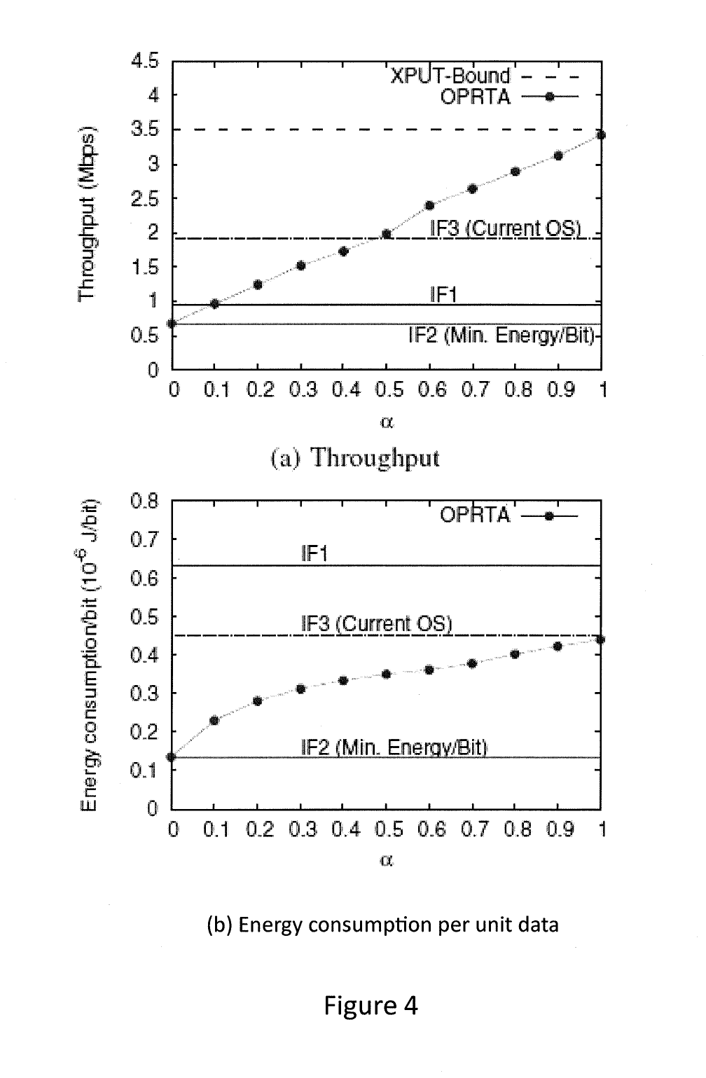

User Utility: In this example, the effect of changing the parameter α on performance is examined. FIG. 4 shows that the invention adapts to different user utility functions. When the user is more concerned with energy consumption, (i.e., α=0) minimum energy consumption can be provided by scheduling all traffic on the interface with minimum energy consumption. On the other hand, when the user's main concern is throughput (i.e., α=1), all interfaces are leveraged to maximize the throughput while increasing the energy consumption.

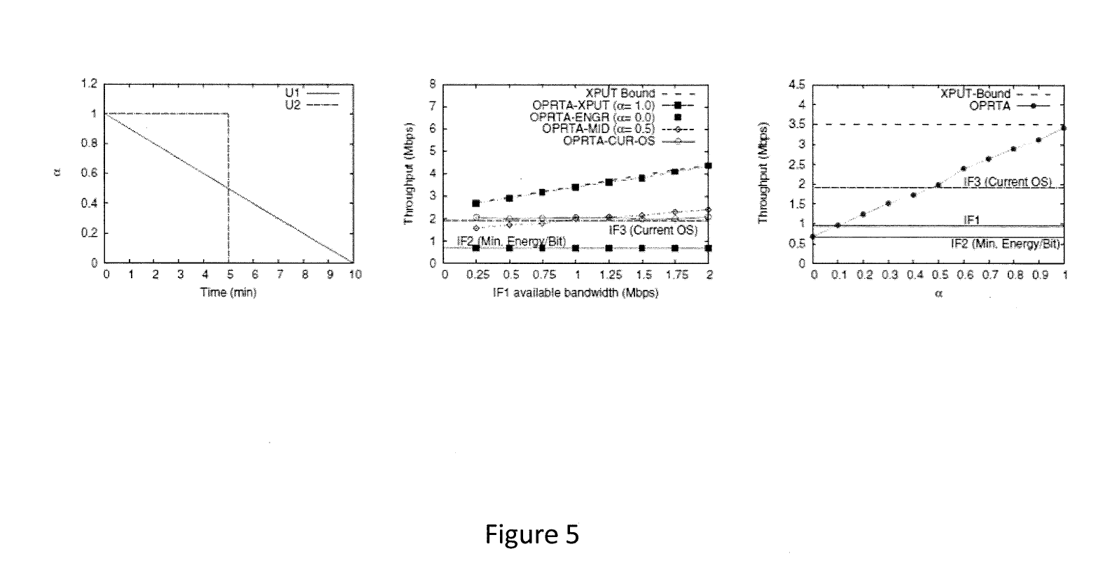

To provide further insight about the system dynamics, the instantaneous values of the data transmitted and energy consumed for two different user utility functions are shown (FIG. 5). (1) U1 represents the case where utility decreases linearly with time. This can be the case when utility is proportional to the remaining battery level. (2) U2 represents the case where the user's value of the energy consumption suddenly switches. This can be the case when the user sets a threshold on the minimum battery level for high performance after which he switches to an energy-saving mode.

FIG. 5 shows that the utility functions captures user intent; the linear utility function has both linear throughput and energy consumption. The step utility function changes both the throughput and energy consumption at the change point (t=5 min). Overall, we observe that the smoother the utility function the better it performs.

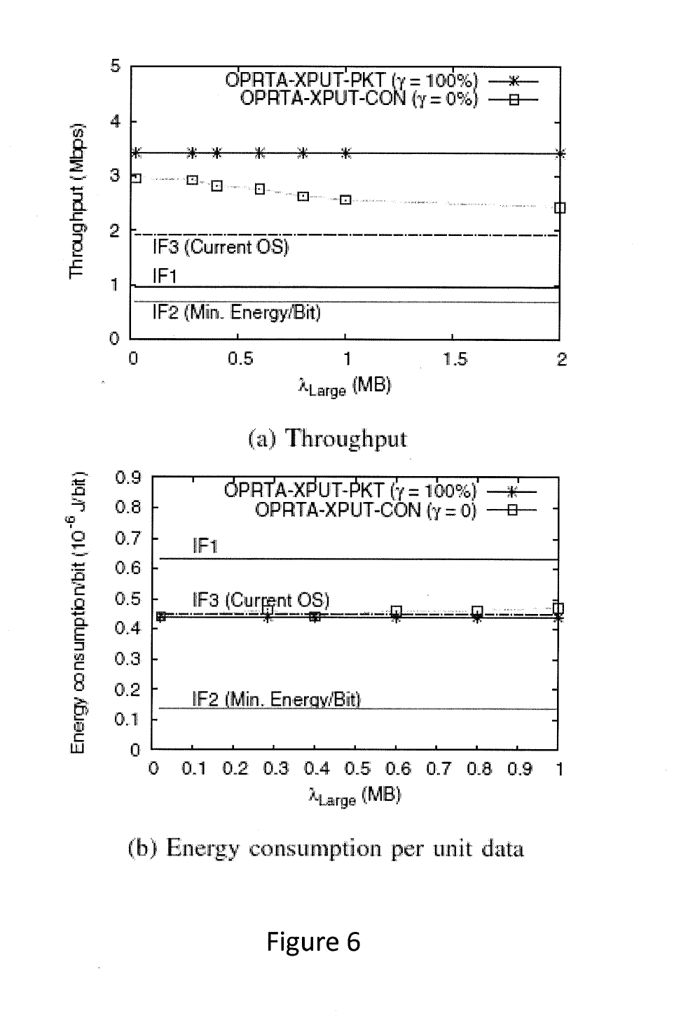

Impact of the Connection Heterogeneity (λ_{Large}): FIG. 6 demonstrates the effect of skewing the distribution of the connection length, i.e. fixing λ_{Small} and increasing λ_{Large}. We observe that as the connection lengths are more heterogeneous, the connection-oriented scheduler suffers from the coarse grained scheduling granularity and deviates from the optimal performance. The packet-oriented variant (γ=100), is not affected by the heterogeneity as its scheduling granularity is packet-based. This result further highlights that performance can be incrementally enhanced as more servers become enabled.

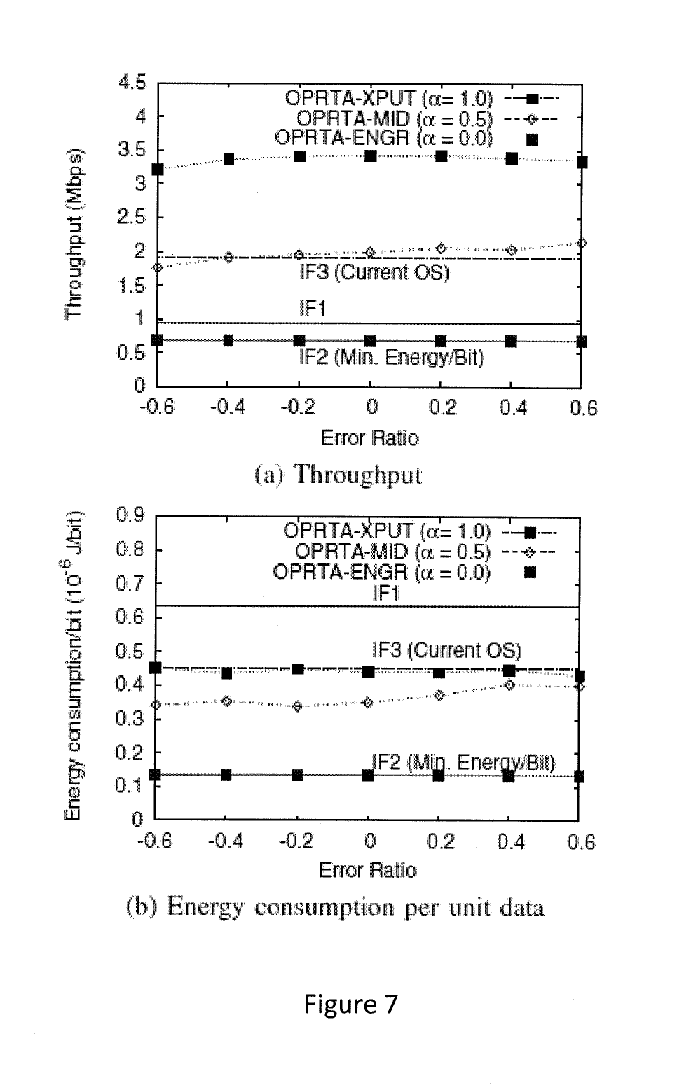

Robustness to Estimation Error: In this example, the robustness of the invention to error in the estimation of application characteristics was evaluated. A severe error model was used where the estimator consistently causes a fixed error ratio. FIG. 7 shows that different variants are not sensitive to error in application characteristics estimation. FIG. 7 also shows that the estimation error mainly impacts energy consumption. This result comes with an increase in throughput, which exceeds the user defined threshold. However, the impact of loss in optimality on throughput is negligible. This is because we have two different behaviors.

For OPRTA-XPUT, both overestimating the mean stream demand as well as underestimating it decreases the overall system throughput because all the interfaces are balanced and utilized to their maximum. Incurring estimation errors affects this balance, which would lead to the decrease in the overall systems throughput. However, it is observed that underestimating the mean stream demand is more critical because it makes the scheduler push more streams on the low bandwidth interface. On the other hand, for OPRTA-MID we observe that underestimating the mean connection demand renders the scheduler unable to achieve the required throughput, while overestimating it makes the scheduler push more data onto the high bandwidth interfaces achieving 11% more throughput than needed with consuming energy at 114% of the optimal energy consumption. Similar results were obtained when we tested other less severe error models.

Comparison with Baseline Schedulers: In this example, we compare the performance of the OPRTA-XPUT (α=1) with the round robin and weighted round robin schedulers. We fix the bandwidth of IF₂ and IF₃ as shown in Table 3 and change the bandwidth of IF₁ from 0.25 to 2 Mbps.

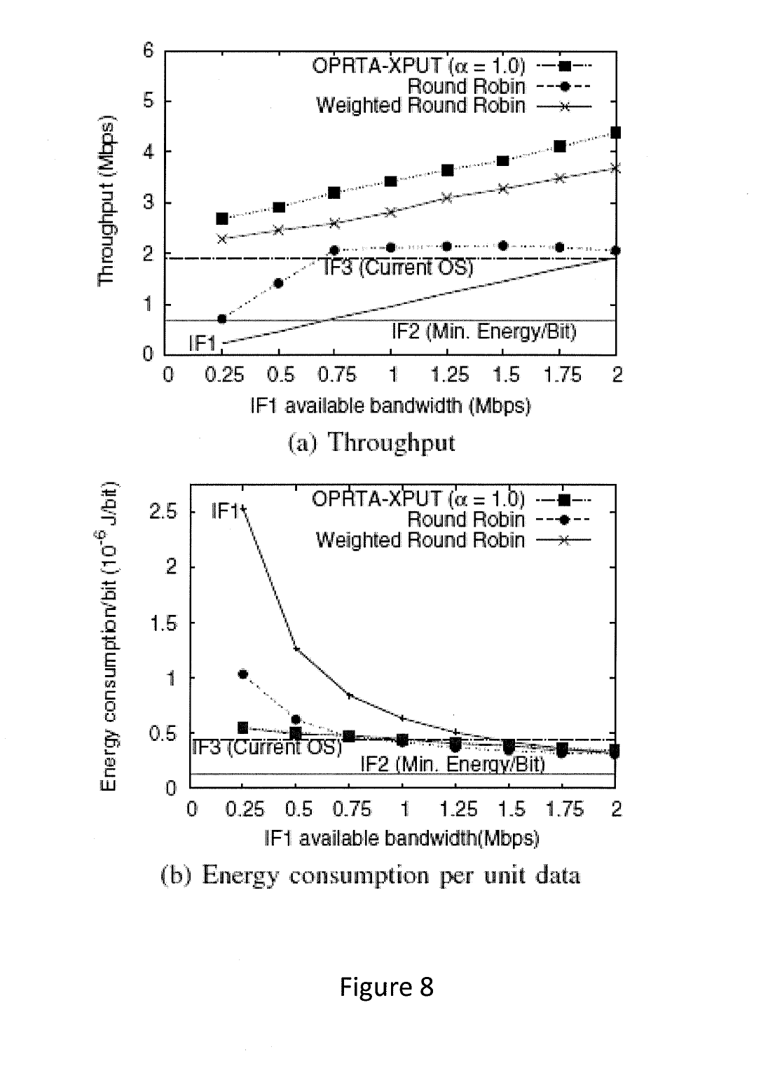

FIG. 8 shows that both the OPRTA-XPUT and weighted round robin schedulers exploit the heterogeneity of the interfaces to achieve high throughput. However, as the overall available bandwidth increases, OPRTA-XPUT's advantage increases as it takes into account the application characteristics. On the other hand, the round robin scheduler assigns the same amount of data to each interface. Therefore, the low bandwidth interface becomes a performance bottleneck. Both baseline schedulers are far from the optimal throughput.

In terms of the energy consumption per unit data, a similar trend is observed; the round robin scheduler performs the worst as it does not take the interface characteristics into account. The OPRTA-XPUT variant consumes almost the same energy as the weighted round robin with significant gain in throughput.

In conclusion, the invention achieves a user defined throughput with optimal minimum energy-consumption while maintaining the core features of being deployable, as well as providing incremental performance gain as it becomes more adopted over the Internet. The invention can be tuned to achieve different user utility goals. In the throughput maximization mode, it can provide more than 150% enhancement in throughput compared to the current operating systems, with no changes to the current legacy servers. This result comes with no increase in energy consumption. Moreover, the performance gain increases with the increase in percentage of enabled servers, reaching the maximum achievable throughput with changes to as few as 25% of servers. We also showed that in order to achieve the same throughput as current operating systems requires significantly less energy (saving up to 44%).

The present invention has been described in accordance with several examples, which are intended to be illustrative in all aspects rather than restrictive. Thus, the present invention is capable of many variations in detailed implementation, which may be derived from the description contained herein by a person of ordinary skill in the art. The intended scope of the invention is as claimed.

We claim:

1. A system for bandwidth aggregation implemented as software on a computing device having multiple network interfaces, comprising,
a scheduling module, said scheduling module assigning data streams for one or more applications to one or more of said multiple network interfaces;
an application characteristics estimating module, for determining the behavior of individual applications running on said computing device;
wherein said scheduling module assigns data streams to network interfaces to optimize throughput, energy consumption or a combination of throughput and energy consumption, based on a user preference.

2. The system of claim 1 wherein said application characteristics estimator stores application characteristics in a database, and further wherein said characteristics include information regarding usage of said network interfaces.

3. The system of claim 1 further comprising:
an interface characteristics estimating module, for determining the characteristics of said multiple network interfaces.

4. The system of claim 3 wherein said interface characteristics include available bandwidth and energy consumption.

5. The system of claim 1 further comprising a battery sensor, for determining if said device is connected to a power source, and the current state of charge of a battery in said device.

6. The system of claim 3 wherein said schedule assigns streams to interfaces to achieve a user-specified throughput goal while minimizing energy consumption.

7. The system of claim 3 further comprising:
a mode detection module, for determining if servers to which said one or more applications are connected are able to receive a data stream having data packets transmitted over multiple network interfaces.

8. The system of claim 7 wherein said mode detection module makes said determination by attempting to connect to a specific port on said servers.

9. The system of claim 7 wherein said scheduling module breaks a data stream from a single application into packets and transmits said packets on one or more of said network interfaces, if said server to which said data stream is being transmitted is able to receive said data stream on multiple network interfaces.

10. The system of claim 9 wherein a header is attached to each of said data packets providing information regarding the ordering of said data packets.

11. The system of claim 9 wherein a user is able to specify the trade-off between throughput and energy consumption and further wherein said scheduling module optimizes energy consumption after a specified throughput is achieved.

12. The system of claim 11 wherein said scheduler assigns data streams or data packets to a specific network interface to meet said energy consumption and throughput constraints based on input from said application characteristics estimator module and said interface characteristics estimating module.

13. The system of claim 1 wherein said software runs between an operating system on said computing device and any application running on said computing device, thereby requiring no changes to legacy software.

14. A method for bandwidth aggregation implemented as software on a computing device having multiple network interfaces, comprising the steps of:
determining the required bandwidth characteristics of applications running on said computing device; and
assigning data streams from applications to network interfaces to optimize throughput, energy consumption or a combination of throughput and energy consumption, using said determined bandwidth requirements of said application as input to an algorithm which makes said assignments.

15. The method of claim 14 wherein said optimization is based on a stated user preference.

16. The method of claim 14 further comprising the steps of:
determining if a remote server to which an application wishes to send data is capable of receiving said data on multiple network interfaces; and
breaking data streams from such applications into packets which are sent to said remote server over multiple network interfaces.

17. The method of claim 16 further comprising adding a header to each of said packets, said header specifying the order in which said packets are to be assembled on said remote server.

18. The method of claim 14 further comprising the steps of:
determining the operational characteristics of each of said network interfaces; and
using said determined operational characteristics as input to an algorithm which makes said assignments.

19. The method of claim 18 wherein said algorithm fulfills minimum throughput requirements while minimizing energy consumption.

20. The method of claim 18 wherein said step of determining if a remote server is capable of receiving said data on multiple network interfaces further comprises the steps of:
attempting to connect to a specific port on said remote server; and
if successful, utilizing multiple network interfaces to send data packets to said remote server.
